(19) United States
(12) Patent Application Publication
(10) Pub. No.: US 2023/0117526 A1
(43) Pub. Date: Apr. 20, 2023

(54) METHOD FOR PRODUCING COMPOSITE MOLDED COMPONENT, AND COMPOSITE MOLDED COMPONENT

(71) Applicant: Sumitomo Wiring Systems, Ltd., Yokkaichi-shi, Mie (JP)

(72) Inventors: Takashi NISHIGUCHI, Yokkaichi-shi, Mie (JP); Kyungwoo KIM, Yokkaichi-shi, Mie (JP); Toshinari KOBAYASHI, Yokkaichi-shi, Mie (JP); Yeonsol JEONG, Yokkaichi-shi, Mie (JP); Yukitoshi TERASAKA, Yokkaichi-shi, Mie (JP)

(21) Appl. No.: 17/907,006

(22) PCT Filed: Mar. 2, 2021
(86) PCT No.: PCT/JP2021/007904

§ 371 Date: Sep. 22, 2022

(30) Foreign Application Priority Data
Mar. 23, 2020 (JP) 2020-050504

(51) Int. Cl. B29C 45/78; G01F 1/684; B29C 45/14

(52) U.S. Cl. CPC B29C 45/78; G01F 1/684; B29C 45/14; B29C 2945/7604; B29C 2945/76257; B29C 2945/76551

(57) ABSTRACT

A method for producing a composite molded component that includes an internal component, a primary molded portion covering the internal component, and a secondary molded portion covering the primary molded portion, wherein a rib portion that protrudes toward the secondary molded portion, the method including the steps of: (a) placing an intermediate component including the internal component and the primary molded portion in a mold; (b) pouring a resin for forming the secondary molded portion into the mold; (c) detecting a resin temperature of the resin in the mold; (d) determining, based on the resin temperature, a melting time during which the resin in the mold can be molten and fused to the rib portion of the primary molded portion; (e) determining, based on the melting time, whether a molten state of the rib portion is good or poor; and (f) releasing the composite molded component from the mold.

### CROSS-REFERENCE TO RELATED APPLICATIONS

This application is the U.S. national stage of PCT/JP2021/007904 filed on Mar. 2, 2021 which claims priority of Japanese Patent Application No. JP 2020-050504 filed on Mar. 23, 2020, the contents of which are incorporated herein.

### TECHNICAL FIELD

The present disclosure relates to a method for producing a composite molded component, and a composite molded component.

### BACKGROUND

JP 2017-96828A discloses forming a molded body that integrally includes a holder portion and a detection unit that includes a detection element portion through injection molding or the like, and forming a resin mold portion by subjecting the molded body to injection molding or the like.

JP 563-126717A discloses controlling a molding condition by measuring the surface temperature of a cavity and the heat flux of the cavity using a temperature sensor and comparing measured values with reference values.

A rib may be provided to seal between a primary molded portion and a secondary molded portion. There is a demand to further improve the sealing performance of the rib portion.

Accordingly, it is an object of the present disclosure to further improve the sealing performance of a rib portion.

### SUMMARY

A method for producing a composite molded component according to the present disclosure is a method for producing a composite molded component that includes an internal component, a primary molded portion that covers the internal component, and a secondary molded portion that covers the primary molded portion, wherein a rib portion that protrudes toward the secondary molded portion is formed in the primary molded portion, the method including the steps of (a) placing an intermediate component that includes the internal component and the primary molded portion in a mold; (b) pouring a resin for forming the secondary molded portion into the mold; (c) detecting a resin temperature of the resin for forming the secondary molded portion in the mold; (d) determining, based on the resin temperature, a melting time during which the resin for forming the secondary molded portion in the mold can be molten and fused to the rib portion of the primary molded portion; (e) determining, based on the melting time, whether a molten state of the rib portion is good or poor; and (f) releasing the composite molded component from the mold.

Also, a composite molded component according to the present disclosure is a composite molded component including: an internal component; a primary molded portion that covers the internal component; and a secondary molded portion that covers the primary molded portion, wherein a rib portion that protrudes toward the secondary molded portion is formed in the primary molded portion, and a sensor mark is formed on a surface of the secondary molded portion.

### Advantageous Effects

According to the present disclosure, the sealing performance of the rib portion is further improved.

### BRIEF DESCRIPTION OF DRAWINGS

FIG. 1 is a schematic plan view of a molding apparatus used in a method for producing a composite molded component.

FIG. 2 is a block diagram showing a composite molded component producing apparatus used in the method for producing a composite molded component.

FIG. 3 is a schematic perspective view of composite molded components.

FIG. 4 is a partial cross-sectional view of a composite molded component.

FIG. 5 is a flowchart of a method for producing a composite molded component.

FIG. 6 is a flowchart illustrating an example of processing performed by a control apparatus.

FIG. 7 is a diagram showing an example of a change in resin temperature with time.

FIG. 8 is a flowchart illustrating processing according to a variation.

FIG. 9 is a flowchart illustrating processing according to another variation.

FIG. 10 is a flowchart illustrating processing according to yet another variation.

FIG. 11 is a flowchart illustrating processing according to yet another variation.

### DETAILED DESCRIPTION OF PREFERRED EMBODIMENTS

First, aspects of an embodiment according to the present disclosure will be listed and described.

A method for producing a composite molded component according to the present disclosure will be described below.

### First Aspect

A method, in accordance with a first aspect, for producing a composite molded component that includes an internal component, a primary molded portion that covers the internal component, and a secondary molded portion that covers the primary molded portion, wherein a rib portion that protrudes toward the secondary molded portion is formed in the primary molded portion, the method including the steps of (a) placing an intermediate component that includes the internal component and the primary molded portion in a mold; (b) pouring a resin for forming the secondary molded portion into the mold; (c) detecting a resin temperature of the resin for forming the secondary molded portion in the mold; (d) determining, based on the resin temperature, a melting time during which the resin for forming the secondary molded portion in the mold can be molten and fused to the rib portion of the primary molded portion; (e) determining, based on the melting time, whether a molten state of the rib portion is good or poor; and (f) releasing the composite molded component from the mold. The melting time during which the resin for forming the secondary molded portion in the mold can be molten and fused to the rib portion of the primary molded portion is determined based on the resin temperature, and whether the molten state of the rib portion is good or poor is determined based on the melting time. Accordingly, the molten state of the rib portion can be more accurately determined. By obtaining the molten state of the rib portion, the sealing performance of the rib portion can be further improved.

### Second Aspect

In a second aspect, the method for producing a composite molded component according to the first aspect may further include the step of (g) when it is determined in the step (f) that the molten state of the rib portion is poor, discarding the composite molded component that has been released from the mold. When it is determined that the molten state of the rib portion is poor, the composite molded component can be easily discarded.

### Third Aspect

In a third aspect, the method for producing a composite molded component according to the first or the second aspect may further include the step of (h) when it is determined that the molten state of the rib portion is poor, changing a molding condition for next molding. It is possible to suppress a situation from occurring in which a composite molded component produced in the next molding is determined as a defective composite molded component.

### Fourth Aspect

In a fourth aspect, the method for producing a composite molded component according to any one of the first to the third aspect, in the step (e), whether the molten state of the rib portion is good or poor may be determined based on an integral value of the resin temperature during the melting time. It is possible to determine whether the molten state of the rib portion is good or poor by referring to the melting time and the resin temperature.

### Fifth Aspect

In a fifth aspect, the method for producing a composite molded component according to any one of the first to the fourth aspects, may further include the step of (i) determining, based on a first temperature sensor and a second temperature sensor that are provided spaced apart from each other in the mold, a resin inflow rate of the resin for forming the secondary molded portion into the mold. The inflow state of the resin into the mold can be monitored.

### Sixth Aspect

In a sixth aspect, the method for producing a composite molded component according to any one of the first to the fifth aspects may further include the step of (j), determining, based on the resin temperature of the resin for forming the secondary molded portion in the mold, whether or not the internal component satisfies a thermal condition. It is possible to determine whether or not the internal component satisfies a thermal condition.

### Seventh Aspect

In a seventh aspect, the method for producing a composite molded component according to any one of the first to the sixth aspects, in the step (c), the resin temperature of the resin for forming the secondary molded portion in the mold may be a temperature of an extension of a surface of a portion of the resin for forming the secondary molded portion that covers the rib portion. The molten state of the rib portion can be more accurately determined based on the resin temperature near the rib portion.

### Eighth Aspect

The method for producing a composite molded component according to any one of the first to the seventh aspect may further include the step of (k) determining a feeding state of the resin for forming the secondary molded portion into the mold based on a pressure sensor that is provided in a mold surface of the mold at a position that is closer to an end of the mold and spaced apart from a resin injection inlet for injecting the resin for forming the secondary molded portion. It is possible to determine whether the mold is sufficiently filled with the resin for forming the secondary molded portion.

A composite molded component according to the present disclosure will be described below.

### Ninth Aspect

A composite molded component including: an internal component; a primary molded portion that covers the internal component; and a secondary molded portion that covers the primary molded portion, wherein a rib portion that protrudes toward the secondary molded portion is formed in the primary molded portion, and a sensor mark is formed on a surface of the secondary molded portion. The sensor mark is formed on the surface of the secondary molded portion, and it is therefore possible to know the condition for forming the secondary molded portion based on a sensor that was disposed on the sensor mark. This configuration can contribute to further improvement of the sealing performance of the rib portion.

### Tenth Aspect

In the composite molded component according to the ninth aspect, the sensor mark may include a first sensor mark and a second sensor mark that are formed at positions spaced apart from each other on the surface of the secondary molded portion. The condition of the resin for forming the secondary molded portion can be obtained at the positions spaced apart from each other.

### Eleventh Aspect

In the composite molded component according to the ninth or the tenth aspect, a resin injection inlet mark may be formed on the surface of the secondary molded portion, and an end portion sensor mark may be formed in the surface of the secondary molded portion at a position that is closer to an end of the secondary molded portion and spaced apart the resin injection inlet mark. It is possible to determine whether the mold is sufficiently filled with the resin for forming the secondary molded portion.

Specific examples of the method for producing a composite molded component and the composite molded component according to the present disclosure will be described below with reference to the accompanying drawings. It is to be noted that the present disclosure is not limited to examples given below, the scope of the present disclosure is indicated by the appended claims, and all changes that come within the meaning and range of equivalency of the claims are intended to be embraced within the scope of the present disclosure.

### Embodiment

Hereinafter, a method for producing a composite molded component and a composite molded component according to an embodiment will be described.

### Composite Molded Component and Composite Molded Component Producing Apparatus

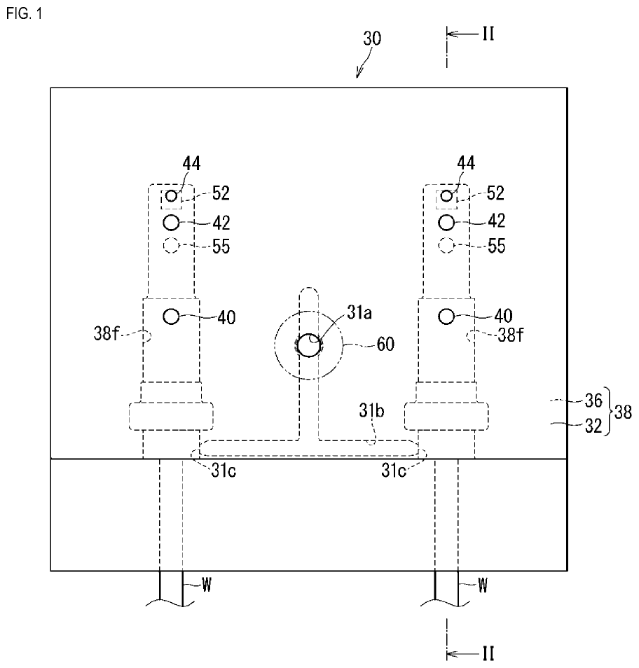

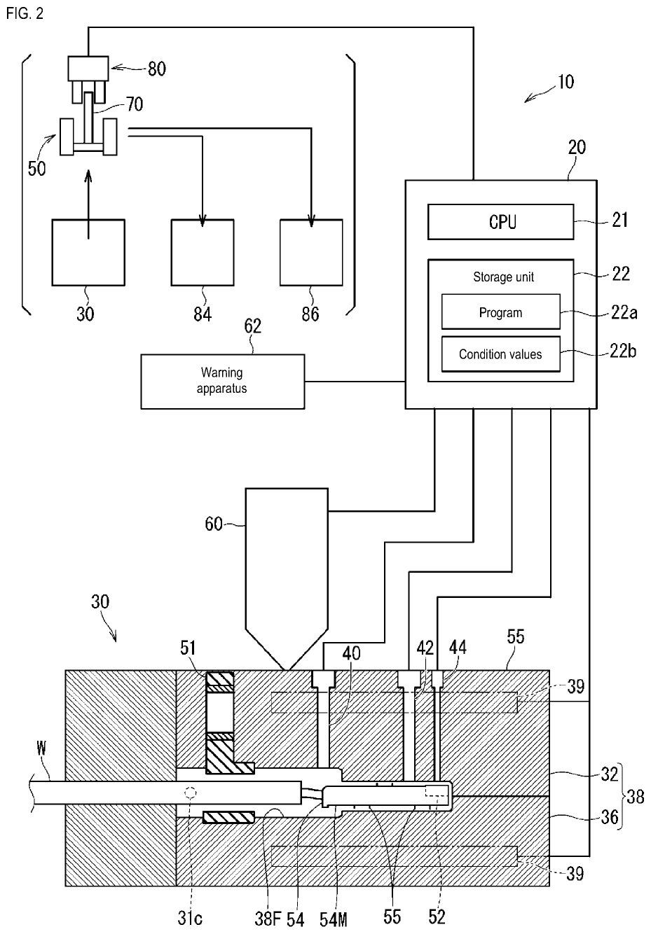

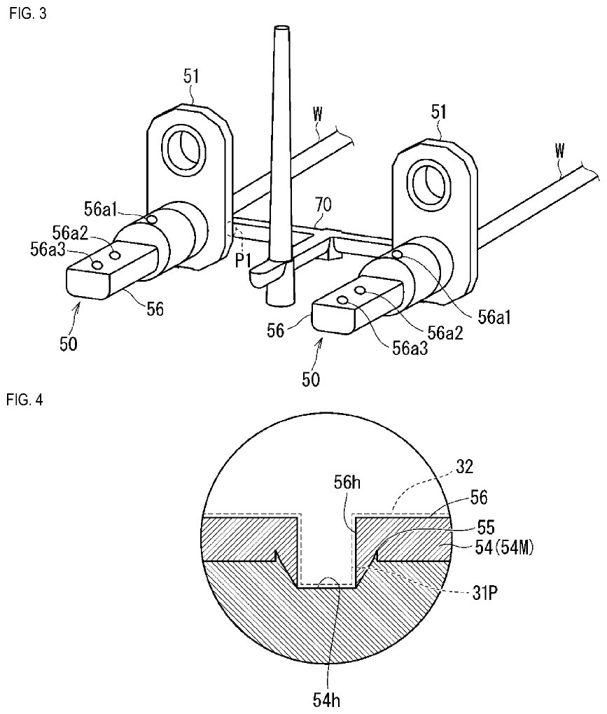

FIG. 1 is a schematic plan view of a molding apparatus 30 used in a method for producing a composite molded component. FIG. 2 is a block diagram of a composite molded component producing apparatus 10 used in the method for producing a composite molded component. FIG. 2 shows a cross-sectional view of the molding apparatus 30 taken along the line II-II shown in FIG. 1. FIG. 3 is a schematic perspective view of composite molded components 50. FIG. 3 shows two composite molded components 50 that are connected via a runner mark portion 70. FIG. 4 is a partial cross-sectional view of a composite molded component 50.

Each composite molded component 50 includes an internal component 52, a primary molded portion 54, and a secondary molded portion 56. In FIGS. 1 to 3, a screw retaining portion 51 for screwing the composite molded component 50 to an attachment target portion is also integrally formed with the secondary molded portion 56. The screw retaining portion 51 may be omitted.

The internal component 52 is a component that is covered by the primary molded portion 54 and the secondary molded portion 56, and may be, for example, an electric component (see FIG. 1). More specifically, the internal component 52 is a sensor element that detects a physical quantity such as magnetism, light, or temperature, or the amount of change thereof. A terminal of the internal component 52 is connected to a core wire of an electric wire W. The electric wire W extends to the outside through the primary molded portion 54 and the secondary molded portion 56. An output signal of the internal component may be output to the outside via the electric wire W.

The primary molded portion 54 and the secondary molded portion 56 cover the internal component 52. In this example, the primary molded portion 54 and the secondary molded portion 56 are portions formed using a resin. The primary molded portion 54 and the secondary molded portion 56 may be formed using, for example, PE (polyethylene), a polyamide, PBT (polybutylene terephthalate), or the like. The primary molded portion 54 is a portion that holds the internal component 52. The secondary molded portion 56 is a portion that covers the primary molded portion 54. Because the internal component 52 is embedded within the primary molded portion 54 and the secondary molded portion 56, the sealing property for sealing the internal component 52 is increased.

More specifically, the primary molded portion 54 is a portion that covers the internal component 52. An intermediate component 54M is a component obtained by integrally forming the primary molded portion 54 and the internal component 52 into a single component, with the primary molded portion 54 covering the internal component 52. For example, the primary molded portion 54 is a molded portion including the internal component 52 as an insert component. FIG. 2 shows a state in which a primary molded portion 54 that covers an internal component 52 is positioned in the molding apparatus 30. The primary molded portion 54 has a rectangular parallelepiped shape. The internal component 52 is contained in the primary molded portion 54 at a position that is closer to a main surface of the primary molded portion 54 and is at an end portion of the primary molded portion 54 in the lengthwise direction thereof. The electric wire W connected to the internal component 52 passes through the primary molded portion 54 and extends toward the other end of the primary molded portion 54. The primary molded portion 54 does not necessarily need to cover the entire internal component 52, and may cover at least a portion of the internal component 52. It is not essential to mold the primary molded portion 54 to include the internal component 52 as an insert component. The primary molded portion 54 may be molded into a shape into which the internal component 52 can be fitted, and the internal component 52 may be fitted into the primary molded portion 54.

The secondary molded portion 56 covers the primary molded portion 54. The secondary molded portion 56 may cover the entire perimeter of the primary molded portion 54 or a portion of the primary molded portion 54. In this example, the secondary molded portion 56 covers the entire primary molded portion 54 excluding a portion of the primary molded portion 54 used for positioning. That is, the primary molded portion 54 is positioned in the molding apparatus 30 at a fixed position by a positioning pin 31P that protrudes toward a mold space (see FIG. 4).

The secondary molded portion 56 has an elongated rectangular parallelepiped outer shape. The internal component 52 is embedded in a portion closer to an end portion of the secondary molded portion 56. The electric wire W extends from one end portion of the primary molded portion 54, passes through the secondary molded portion 56, and extends to the outside from the other end portion of the secondary molded portion 56. The secondary molded portion 56 does not necessarily need to have a rectangular parallelepiped outer shape.

A rib portion 55 that protrudes toward the secondary molded portion 56 is formed in the primary molded portion 54. The rib portion 55 is a portion that functions to more reliably suppress the intrusion of water through an interface between the primary molded portion 54 and the secondary molded portion 56.

That is, a cavity 56h that extends from the surface of the secondary molded portion 56 to the primary molded portion 54 is formed in the secondary molded portion 56 (see FIG. 4). In the case where the secondary molded portion 56 is molded using the internal component 52 and the primary molded portion 54 as insert objects, as described above, the primary molded portion 54 is positioned and held by the positioning pin 30P The rib portion 55 is an annular rib portion that surrounds the cavity 56h. The rib portion 55 is preferably inversely tapered toward a tip end of the rib portion 55 in the protruding direction of the rib portion 55. In this example, a blind hole 54h into which the positioning pin 30P can be fitted and that has a bottom is formed at the center of the rib portion 55 in the surface of the primary molded portion 54. By fitting the positioning pin 30P into the blind hole 54h, the primary molded portion 54 is more accurately positioned when molding the secondary molded portion 56. It is not essential to form a blind hole 54h. The blind hole 54h does not reach the internal component 52.

In the case where the secondary molded portion 56 is molded using the primary molded portion 54 as an insert object, a resin for molding the secondary molded portion 56 that has been heat-molten is injected into the molding apparatus 30. The heat-molten resin rapidly cools and solidifies upon coming into contact with the surface of the primary molded portion 54. At the tip end portion of the rib portion 55, the heat-molten resin does not cool as rapidly as when it comes into contact with the surface of the primary molded portion 54. For this reason, it is expected that the heat-molten resin for forming the secondary molded portion 56 is fused to the tip end portion of the rib portion 55. As a result, at the interface between the primary molded portion 54 and the secondary molded portion 56, perfect water sealing is achieved along with the rib portion 55. The rib portion 55 may also be called a “melt rib”. The primary molded portion 54 and the secondary molded portion 56 are preferably formed using the same material such that the rib portion 55 and the secondary molded portion 56 are easily fused to each other.

Particularly in the case where the positioning cavity 56h is formed, the interface between the primary molded portion 54 and the secondary molded portion 56 is exposed to the outside through the cavity 56h. Accordingly, the rib portion 55 is formed to surround the cavity 56h. With this configuration, it is possible to suppress a situation from occurring in which water enters between the primary molded portion 54 and the secondary molded portion 56 via the cavity 56h and flows into the internal component 52.

In order to further enhance the water sealing effect achieved by the rib portion 55, the tip end portion of the rib portion 55 is preferably fused to the resin forming the secondary molded portion 56 (hereinafter also referred to as a “fused state”). However, the rib portion 55 itself is embedded within the secondary molded portion 56, and thus even when a produced composite molded component 50 is observed, it is not possible to directly check the fused state.

The following methods may be conceived to more reliably fuse the tip end portion of the rib portion 55 to the resin for forming the secondary molded portion 56: increasing the resin temperature of the resin for forming the secondary molded portion 56 that is injected into the molding apparatus 30 to a temperature as high as possible; extending the period of time during which the resin temperature of the resin for forming the secondary molded portion 56 in the molding apparatus 30 is kept at a high temperature; and the like. However, taking a thermal influence on the internal component 52, the request to shorten the molding time as short as possible, and the like into consideration, there are limits to increasing the resin temperature and extending the period of time during which the resin temperature in the molding apparatus 30 is kept at a high temperature.

Under the circumstances described above, the present disclosure relates to a technique for further improving the sealing performance achieved by the rib portion by more reliably fusing the tip end portion of the rib portion to the resin that forms the secondary molded portion 56.

The composite molded component producing apparatus 10 used in the method for producing a composite molded component 50 according to the present disclosure includes a molding apparatus 30, a resin injection apparatus 60, and a control apparatus 20.

The molding apparatus 30 includes an upper mold 32 and a lower mold 36. A mold 38 for molding a composite molded component 50 is configured by the upper mold 32 and the lower mold 36. The mold 38 has a mold surface 38F for forming the surface of the secondary molded portion 56. The mold space into which the resin for forming the secondary molded portion 56 flows is formed in the mold surface 38F. In the present embodiment, each of the upper mold 32 and the lower mold 36 is composed of a portion for holding the electric wire W and the remaining portion, but this configuration is not essential.

In the present embodiment, a plurality of (two in this example) mold surfaces 38F are formed in the molding apparatus 30. In the molding apparatus 30, a flow path 31b, such as a runner, is formed that extends from an introduction inlet 31a and is branched into injection inlets 31c that are open to the plurality of mold surfaces 38F, respectively. In this example, the flow path 31b has a shape that includes a portion that is branched into a T shape. A runner mark portion 70 that corresponds to the flow path 31b is connected to a lateral portion of the secondary molded portion 56 at a position closer to the other end portion of the secondary molded portion 56. For this reason, when the runner mark portion 70 is cut and removed from the secondary molded portion 56, a resin injection inlet mark P1 may be left in the lateral portion of the secondary molded portion 56 at the position closer to the other end portion of the secondary molded portion 56.

Temperature sensors 40 and 42 are provided in the mold 38. In this example, the temperature sensors 40 and 42 are provided in the upper mold 32. More specifically, through holes that extend from the surface of the upper mold 32 to the mold surface 38F are formed. The temperature sensors 40 and 42 are provided in the through holes to extend therethrough. The temperature detection surfaces of the temperature sensors 40 and 42 at one end portions thereof are exposed on the mold surface 38F, and thus the temperature sensors 40 and 42 can detect the resin temperature in the mold space on an extension of the mold surface 38F. The other end portions of the temperature sensors 40 and 42 are exposed to the outside of the upper mold 32, and detection signals are output via electric wires or the like.

The positioning pin 30P of the upper mold 32 is brought into contact with the primary molded portion 54 in the mold 38 from above. The rib portion 55 is formed in a portion of the primary molded portion 54 that surrounds the positioning pin 30P of the upper mold 32 (see FIGS. 2 and 4). Accordingly, the temperature detection surfaces of the temperature sensors 40 and 42 are located along an extension of the surface of a portion of the resin for forming the secondary molded portion 56 that covers the rib portion 55. Thus, the resin temperature detected by the temperature sensors 40 and 42 is the temperature of the resin for forming the secondary molded portion 56 in the mold 38, and is also the temperature on the extension of the surface of the portion of the resin for forming the secondary molded portion 56 that covers the rib portion 55. The temperature sensors 40 and 42 are preferably provided at positions close to the rib portion 55. For example, the temperature sensors 40 and 42 are preferably provided at positions adjacent to the rib portion 55. The thickness of the secondary molded portion 56 at portions where the temperature sensors 40 and 42 are provided is preferably the same as the thickness of the secondary molded portion 56 at a portion where the rib portion 55 is provided. The temperature sensors 40 and 42 may be provided at positions different from the positions described above such as, for example, in portions of the lower mold 36 or on a lateral portion of the secondary molded portion 56.

Also, in the present embodiment, the temperature sensors 40 and 42 include a first temperature sensor 40 and a second temperature sensor 42. The first temperature sensor 40 and the second temperature sensor 42 are provided at positions spaced apart from each other. Preferably, the first temperature sensor 40 and the second temperature sensor 42 are provided at positions spaced apart from the resin injection inlet 31c by different distances. The distance between the first temperature sensor 40 and the second temperature sensor 42 is set to a known design value.

The mold surface 38F and the temperature detection surfaces of the temperature sensors 40 and 42 are preferably provided on the same plane, but this configuration may cause a small gap or height step. For this reason, marks may be left on the surface of the secondary molded portion 56 at portions corresponding to the positions of the temperature sensors 40 and 42. In the present embodiment, a first sensor mark 56a1 and a second sensor mark 56a2 may be left on the surface of the secondary molded portion 56 at positions spaced apart from each other.

A pressure sensor 44 is also provided in the mold 38. In this example, the pressure sensor 44 is provided in the upper mold 32. More specifically, a through hole that extends from the surface of the upper mold 32 to the mold surface 38F is formed. The pressure sensor is provided in the through hole to extend therethrough. The pressure detection surface of the pressure sensor 44 at one end portion thereof is exposed on the mold surface 38F, and thus the pressure sensor 44 can detect the resin pressure in the mold space on an extension of the mold surface 38F. The other end portion of the pressure sensor 44 is exposed to the outside of the upper mold 32, and a detection signal is output via an electric wire or the like.

The pressure sensor 44 is provided at a position that is spaced apart from the injection inlet 31c for injecting the resin for forming the secondary molded portion 56 and is closer to the end portion of the secondary molded portion 56. Specifically, the pressure sensor 44 is provided at a position opposite to the position of the injection inlet 31c in the lengthwise direction of the secondary molded portion 56. The pressure sensor 44 is preferably provided at a position as close as possible to the end portion of the secondary molded portion 56 such as at a position spaced apart from the end portion of the secondary molded portion 56 by a distance of 1 cm or less. In this example, the pressure sensor 44 is provided at a position more spaced apart from the injection inlet 31c than the temperature sensors 40 and 42. The pressure sensor 44 is provided at a position where it faces the internal component 52.

The mold surface 38F and the temperature detection surface of the pressure sensor 44 are preferably provided on the same plane, but this configuration may cause a small gap or height step. For this reason, a mark may be left on the surface of the secondary molded portion 56 at a portion corresponding to the position of the pressure sensor 44. In the present embodiment, a pressure sensor mark 56a3 may be left on the surface of the secondary molded portion 56 at a position spaced apart from the injection inlet mark P1.

The molding apparatus 30 may include a heater 39. The mold temperature may be controlled by the heater 39.

The resin for molding the secondary molded portion 56 that has been heat-molten is supplied from the resin injection apparatus 60. The heat-molten resin is injected into the molding apparatus 30 via the injection inlet 31c.

The control apparatus 20 is a computer in which a CPU 21, a storage unit 22, and the like are connected to each other via a bus line. The storage unit 22 may include a ROM, a RAM, and the like. A program 22a, condition values 22b, and the like are stored in the storage unit 22. The CPU 21 is a processor. The program 22a may be installed from an external server apparatus or the like. The program 22a may be stored in recording media such as a CD-ROM, a DVD-ROM, and a semiconductor memory, and distributed.

The control apparatus 20 is connected to the temperature sensors 40 and 42 and the pressure sensor 44 via an input output interface. The outputs of the temperature sensors 40 and 42 and the pressure sensor 44 are given to the control apparatus 20.

The control apparatus 20 is connected to the resin injection apparatus 60 and the heater 39 via an input output interface. The control apparatus 20 can control the injection timing, the injection pressure, the injection temperature, and the like of the resin injection apparatus 60. Also, the control apparatus 20 can control the temperature of the molding apparatus 30 by controlling the heater 39.

Also, the control apparatus 20 may be connected to a molded article releasing apparatus 80 via an input output interface. The molded article releasing apparatus 80 is an apparatus that releases a composite molded component 50 from the molding apparatus 30 and transfers the composite molded component 50 to either one of collecting units 84 and 86 such as containers. The molded article releasing apparatus 80 may be implemented by a Cartesian robot or an articulated robot with arms that can hold the composite molded component 50. An accepted composite molded component collecting unit 84 and a defective composite molded component collecting unit 86 may be prepared as the collecting units 84 and 86, and the molded article releasing apparatus 80 may classify and transfer a composite molded component 50 to either one of the collecting units 84 and 86. An example of classification control performed in this case will be described later.

The CPU 21 can perform the following processing for producing a composite molded component 50 based on output results from the temperature sensors 40 and 42, the pressure sensor 44, and the like by performing computation processing in accordance with a procedure written in the program 22a.

The present disclosure can be implemented not only as the control apparatus 20 that includes characteristic processing units described above, but also as a production method that includes characteristic processing operations as steps or a program that causes a computer to execute the steps. The present disclosure can also be implemented as a semiconductor integrated circuit that implements some or all components of the control apparatus or a production system that includes the control apparatus.

In the composite molded component 50 described above, the sensor marks 56a1, 56a2, and 56a3 are formed on the surface of the secondary molded portion 56. Accordingly, it is possible to know a molding condition for molding the secondary molded portion 56 based on the sensors 40, 42, and 44 that were disposed at the positions of the sensor marks 56a1, 56a2, and 56a3. This can contribute to further improvement of the sealing performance of the rib portion 55.

Also, the first sensor mark 56a1 and the second sensor mark 56a2 are formed on the surface of the secondary molded portion 56 at positions spaced apart from each other, and thus the resin temperature for forming the secondary molded portion 56 can be detected at positions spaced apart from each other. With this configuration, for example, resin inflow rate can be obtained.

Also, the sensor mark 56a3 is formed on the surface of the secondary molded portion 56 at a position that is spaced apart from the resin injection inlet mark P1 and is closer to the end portion of the secondary molded portion 56, and thus whether the mold space is sufficiently filled with the resin is determined.

### Method for Producing Composite Molded Component

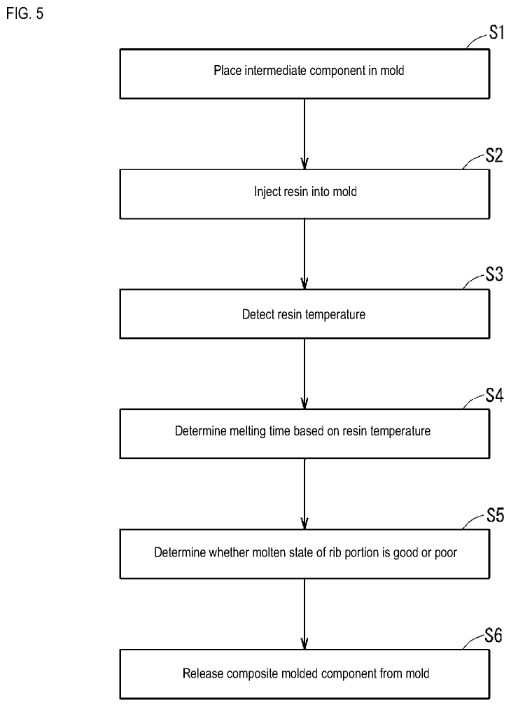

FIG. 5 is a flowchart of a method for producing a composite molded component 50. The method for producing a composite molded component 50 includes steps S1 to S6 described below. The steps shown in FIG. 5 may be performed by a computer or a human.

Step S1 corresponds to the step (a) of placing an intermediate component 54M in the molding apparatus 30. That is, the intermediate component 54M is placed in the molding apparatus 30 such that the intermediate component 54M is positioned by the positioning pin 30P (see FIG. 2). This step may be performed either using a robot that can hold the intermediate component 54M, or manually.

Step S2 corresponds to the step (b) of pouring a resin for forming the secondary molded portion 56 into the mold space of the mold 38. For example, the control apparatus 20 controls the resin injection apparatus 60 to inject a heat-molten resin into the mold space from the resin injection apparatus 60.

Step S3 corresponds to the step (c) of detecting a resin temperature of the resin for forming the secondary molded portion 56 in the mold 38. For example, detection signals of the first temperature sensor 40 and the second temperature sensor 42 that are included in the molding apparatus 30 are output to the control apparatus 20. The control apparatus 20 can thereby obtain the resin temperature.

Step S4 corresponds to the step (d) of determining, based on the resin temperature, a melting time during which the resin for forming the secondary molded portion 56 in the mold 38 can be molten and fused to the primary molded portion 54. That is, as long as the temperature of the heat-molten resin for forming the secondary molded portion 56 is higher than or equal to a melting temperature of a resin for forming the primary molded portion 54, a state is maintained in which the rib portion 55 of the primary molded portion 54 is merged with the resin for forming the secondary molded portion 56. The melting time is, for example, a duration during which the detected resin temperature is higher than or equal to the melting temperature of the resin that forms the rib portion 55 of the primary molded portion 54. The temperature for melting the resin may be set to the melting point or the glass transition temperature of the resin for forming the primary molded portion 54, or a reference temperature that has been set based on the melting point or the glass transition temperature. For example, the measurement positions of the temperature sensors 40 and 42 are located on the mold surface 38F and spaced apart from the primary molded portion 54. In order to obtain the molten state of the rib portion 55, it is desirable to estimate the resin temperature for forming the secondary molded portion 56 at the interface between the primary molded portion 54 and the secondary molded portion 56. Accordingly, a temperature that is higher than the detection temperature detected by the temperature sensors 40 and 42 by a predetermined temperature may be set as the reference temperature.

Step S5 corresponds to the step (e) of determining, based on the melting time, whether the molten state of the rib portion 55 is good or poor. That is, if the melting time is short, the rib portion 55 hardly melts, and it is therefore considered that the molten state is determined as poor. Conversely, if the melting time is long, the rib portion 55 sufficiently melts, and it is therefore considered that the molten state is determined as good. Accordingly, whether the molten state of the rib portion 55 is good or poor can be determined based on the melting time. The determination may be made by taking not only the melting time, but also other factors such as, for example, the resin temperature, into consideration. An example in which whether the molten state of the rib portion 55 is good or poor is determined by taking the melting time and the resin temperature into consideration will be described later.

Step S6 corresponds to the step (f) of releasing the composite molded component 50 from the mold 38. This step may be performed either using a robot that can hold the intermediate component 54M, or manually.

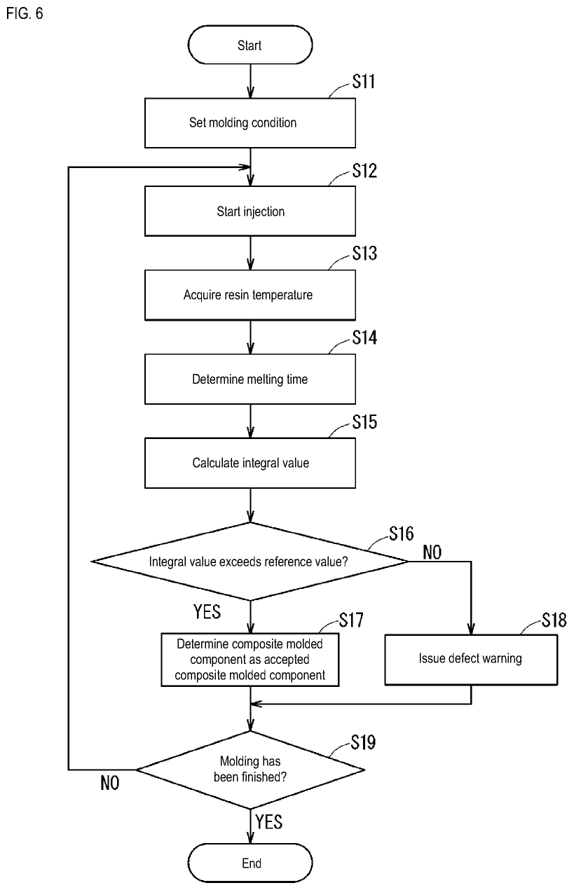

FIG. 6 shows a flowchart illustrating processing, assuming that the processing operations from step S2 to step S5 described above are performed by the control apparatus 20 that is a computer.

In step S11, the control apparatus 20 sets a molding condition. The molding condition includes the pressure of the resin injection apparatus 60, the resin temperature, the heating temperature of the mold 38, and the like. For example, at the start of the processing, pre-set initial values are set as the molding condition.

Next, in step S12, the control apparatus 20 gives an instruction to start injection to the resin injection apparatus 60. In response thereto, a heat-molten resin is injected into the mold space of the mold 38 from the resin injection apparatus 60.

Next, in step S13, the resin temperature is acquired based on the outputs of the temperature sensors 40 and 42.

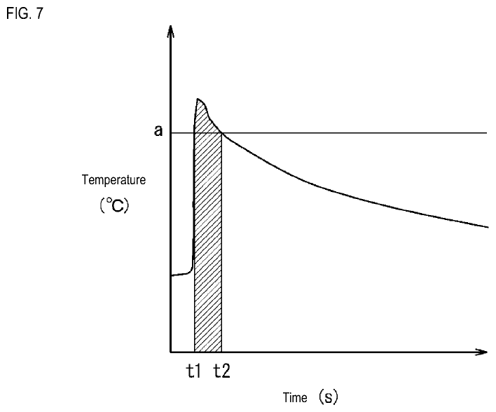

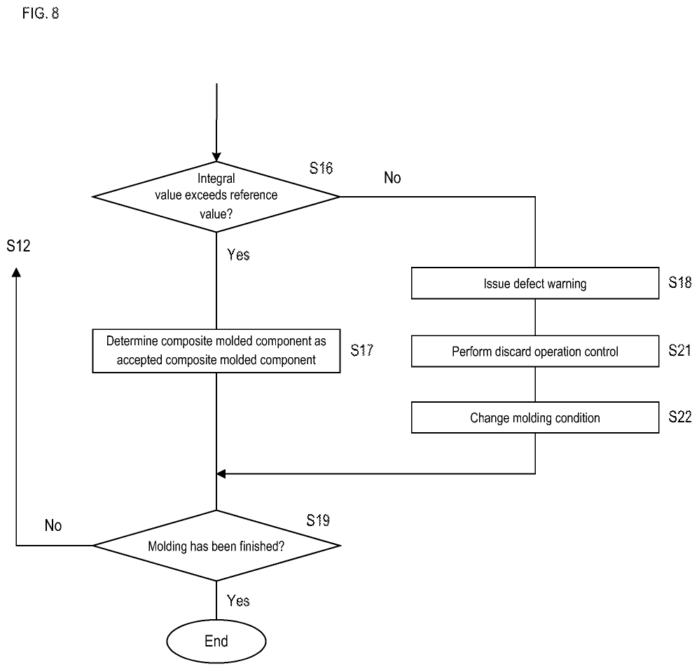

Next, in step S14, the melting time is determined based on the resin temperature. FIG. 7 is a diagram showing an example of a change in the resin temperature. As shown in the diagram, the resin temperature detected by the temperature sensors 40 and 42 sharply increases upon injection of the heat-molten resin into the mold 38, and thereafter gradually decreases. The resin temperature reaches a reference temperature a at time t1, where the reference temperature a represents the temperature at which the resin for forming the rib portion 55 of the primary molded portion 54 melts. After the resin temperature exceeds the peak value, the resin temperature continues to decrease and reaches the reference temperature a at time t2. The period during which the resin temperature was higher than or equal to the reference temperature is the period from time t1 to time t2, and thus the melting time is represented by t2−t1.

Steps S15 and S16 show a specific example of step S5 described above. In step S15, an integral value of the resin temperature during the melting time (the area of the hatched region shown in FIG. 7) is determined. For example, with respect to discrete data of the detected resin temperature, numerical integration is performed on the melting time to determine the integral value of the resin temperature during the melting time. The integral value takes a greater value as the melting time is longer and the resin temperature is higher. That is, the integral value is a value that reflects the melting time and the resin temperature. The integral value may be determined for a value obtained by subtracting a constant (for example, a value obtained by subtracting the reference temperature from the temperature).

In step S16, it is determined whether or not the integral value is less than a reference value. The reference value may be determined by experimentally producing composite molded components 50 at various different temperatures and observing whether the molten state of the rib portion 55 is good or poor for each of the produced composite molded components 50. For example, whether the molten state of the rib portion 55 is good or poor may be determined by performing a test to check whether air leakage occurs between the primary molded portion 54 and the secondary molded portion 56, and determining whether or not the air leakage occurred. Alternatively, whether the molten state of the rib portion 55 is good or poor may be determined by cutting a composite molded component 50 and observing the molten state of the rib portion 55. The reference value may be set to a border value between a condition where it is determined that the molten state of the rib portion 55 is good and a condition where it is determined that the molten state of the rib portion 55 is poor. If the integral value exceeds the reference value, the processing proceeds to step S17, where the composite molded component is determined as an accepted composite molded component. If the integral value does not exceed the reference value, the processing proceeds to step S18, where the composite molded component is determined as a defective composite molded component. If the integral value is equal to the reference value, the composite molded component may be determined as an accepted composite molded component or a defective composite molded component. A defect warning is issued via a warning apparatus 62. As the warning apparatus 62, a light emitting unit, a display device such as a monitor, or a loudspeaker that outputs a sound, or the like can be used. The defect warning may be issued by displaying it on the display device, outputting a warning sound indicating that the composite molded component is a defective composite molded component from the loudspeaker, or the like.

In the case where the plurality of temperature sensors 40 and 42 are provided, the processing operations from step S14 to step S16 described above may be performed on each of the detection results of the temperature sensors 40 and 42, and if it is determined, based on at least one of the detection results, that the molten state of the rib portion 55 is poor, the composite molded component may be determined as a defective composite molded component. Alternatively, the processing operations from step S14 to step S16 described above may be performed on the average value of the detection results of the temperature sensors 40 and 42.

The example of determination processing is not limited to the above-described example. For example, the determination may be made by comparing the melting time with predetermined reference time. Alternatively, the determination may be made by comparing a product or a sum of the melting time and the highest or average value of the resin temperature during the melting time with a predetermined reference value.

After the end of step S17 or S18, the processing proceeds to step S19. In step S19, it is determined whether or not molding has been finished. Whether or not molding has been finished can be determined by determining, for example, whether or not molding has been performed a predetermined number of times corresponding to the pre-set number of composite molded components to be produced. If it is determined that molding has not been finished, the processing returns to step S12, where the above-described processing is repeated. If it is determined that molding has been finished, the processing ends.

According to the method for producing a composite molded component 50 configured as described above, the melting time during which the resin for forming the secondary molded portion 56 in the mold 38 can be molten and fused to the rib portion 55 of the primary molded portion 54 is determined based on the resin temperature, and whether the molten state of the rib portion 55 is good or poor is determined based on the melting time. Accordingly, the molten state of the rib portion 55 can be more accurately determined. By obtaining the molten state of the rib portion 55, the sealing performance of the rib portion 55 can be further improved.

In particular, whether the molten state of the rib portion 55 is good or poor is determined based on the integral value of the resin temperature during the melting time, and it is therefore possible to more accurately determine whether the molten state of the rib portion 55 is good or poor by taking the melting time and the resin temperature into consideration.

Also, the resin temperature for forming the secondary molded portion 56 is the temperature on the extension of the surface of the portion of the resin for forming the secondary molded portion 56 that covers the rib portion 55, and thus the molten state of the rib portion 55 can be more accurately determined based on the resin temperature near the rib portion 55.

### Variation of Method for Producing Composite Molded Components

The production method described above may include the step of (g), when it is determined that the molten state of the rib portion 55 is poor, discarding the composite molded component 50 that has been released from the mold 38.

Also, the production method described above may include the step of (h) when it is determined that the molten state of the rib portion 55 is poor, changing the molding condition for next molding.

A flowchart according to the present variation is shown in FIG. 8. FIG. 8 is different from the flowchart shown in FIG. 6 in that steps S21 and S22 have been added immediately after step S18. That is, after the composite molded component has been determined as a defective composite molded component (after step S18 in FIG. 8), in step S21, discard operation control is performed. The discard operation control is control corresponding to the step (g). For example, the control apparatus 20 may control the molded article releasing apparatus 80 to release the composite molded component 50 from the mold 38 and transfer the composite molded component 50 to the defective composite molded component collecting unit 86. If it is determined that the composite molded component is an accepted composite molded component (step S17), the control apparatus 20 may control the molded article releasing apparatus 80 to release the composite molded component 50 from the mold 38 and transfer the composite molded component to the accepted composite molded component collecting unit 84. The operator may discard the composite molded component 50 that has been released from the mold 38 upon viewing the displayed warning, or hearing the warning sound.

Next, in step S22, the molding condition is changed. Step S22 is control corresponding to the step (h). For example, if the integral value does not exceed the reference value, the resin may be insufficiently heated, and thus at least one of the resin temperature of the resin injection apparatus 60 and the molding temperature of the molding apparatus 30 can be increased. If the integral value significantly exceeds the reference value, the resin may be overheated. Accordingly, contrary to the above, at least one of the resin temperature of the resin injection apparatus 60 and the mold temperature of the molding apparatus 30 can be decreased. As a result, in the next molding, the resin temperature is increased to a high temperature, and it is thereby possible to more reliably melt the rib portion 55.

According to the present variation, if it is determined that the molten state of the rib portion 55 is poor, the composite molded component 50 can be easily discarded.

Also, a situation is suppressed from occurring in which it is successively determined that the molten state of the rib portion 55 is poor. If it is determined, based on the outputs of the temperature sensors 40 and 42, that the temperature of the heat-molten resin is much lower than a predetermined temperature, feedback control may be performed by, for example, increasing the temperature of the heater 39 of the mold 38.

The production method described above may further include the step of (i) determining, based on the first temperature sensor 40 and the second temperature sensor 42, the inflow rate of the resin for forming the secondary molded portion 56 into the mold 38.

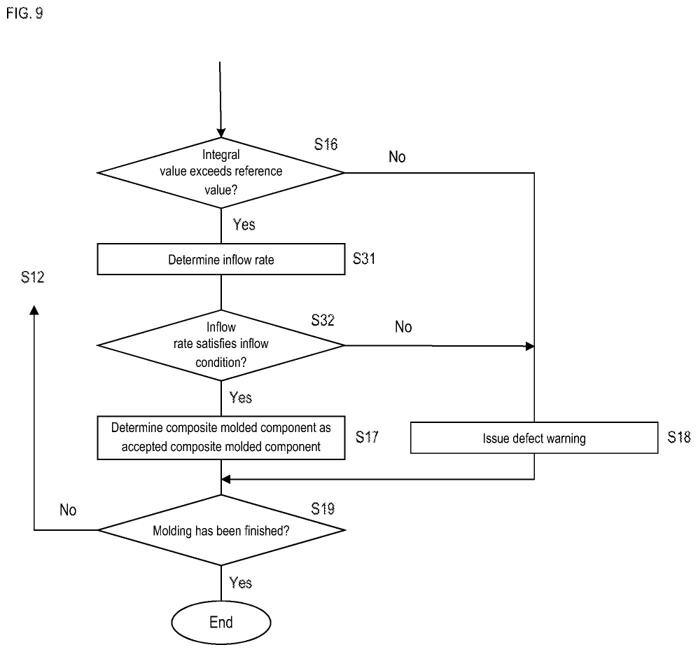

A flowchart according to the present variation is shown in FIG. 9. FIG. 9 is different from the flowchart shown in FIG. 6 in that steps S31 and S32 have been added immediately after step S16. That is, if it is determined in step S16 that the integral value exceeds the reference value, the processing proceeds to step S31. In step S31, inflow rate is determined. The two temperature sensors 40 and 42 are provided at predetermined positions in the mold 38, and thus the distance between the two temperature sensors 40 and 42 is a known design value. Also, the outputs of two temperature sensors 40 and 42 are given to the control apparatus 20, and thus the time when the resin passed through the positions of the two temperature sensors 40 and 42 is determined. For example, the time at which the temperature based on the output results of the two temperature sensors 40 and 42 exceeded a predetermined reference value may be determined as the time when the resin passed through the positions of the temperature sensors 40 and 42. The resin inflow rate is determined by dividing the distance between the two temperature sensors 40 and 42 by the time difference between the time when the resin passed through one of the positions of the two temperature sensors 40 and the time when the resin passed through the other one of the positions of the two temperature sensors 40.

Next, in step S32, it is determined whether or not the resin inflow rate satisfies a predetermined inflow condition. For example, if the inflow rate is low, the resin may not be sufficiently molten or the pressure may be insufficient. Accordingly, the lower limit may be set in advance to the inflow rate. As the inflow condition, a condition where the inflow rate exceeds the lower limit of the inflow rate may be defined. The lower limit of the inflow rate may be determined experimentally or empirically. If it is determined that the resin inflow rate does not satisfy the predetermined inflow condition, the composite molded component is determined as a defective composite molded component, and the processing proceeds to step S18, where a defect warning is issued. If it is determined that the resin inflow rate satisfies the predetermined inflow condition, the composite molded component is determined as an accepted composite molded component, and the processing proceeds to step S17.

According to the present variation, whether or not the resin inflow state is appropriate can be monitored based on the inflow rate of the resin into the mold 38.

The production method described above may further include the step of (j) determining, based on the output results of the temperature sensors 40 and 42, whether or not a thermal condition of the internal component 52 is satisfied.

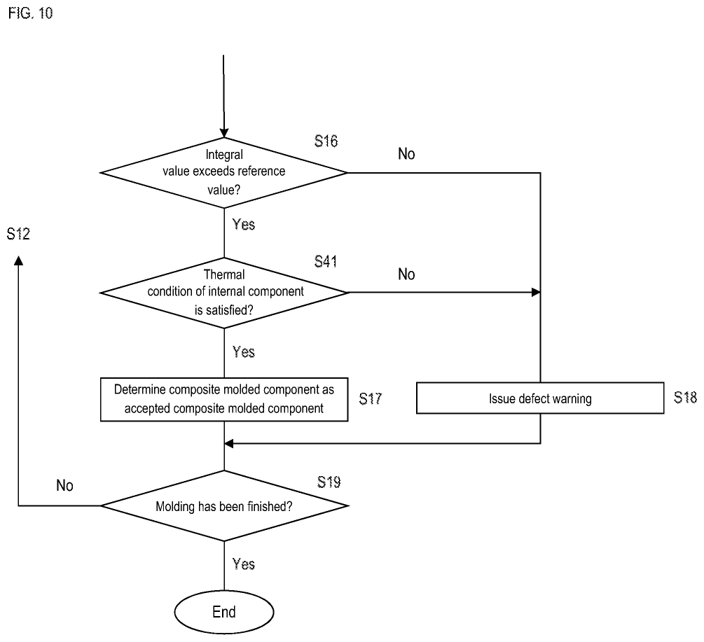

A flowchart according to the present variation is shown in FIG. 10. FIG. 10 is different from the flowchart shown in FIG. 6 in that step S41 has been added immediately after step S16. That is, if it is determined in step S16 that the integral value exceeds the reference value, the processing proceeds to step S41. In step S41, it is determined, based on the output results of the temperature sensors 40 and 42, whether a thermal condition of the internal component 52 is satisfied. As the thermal condition, a temperature to which the internal component 52 can withstand is set. The thermal condition is determined in advance based on the properties and the like of the internal component 52. The thermal condition may be any condition as long as the temperature of the molten resin is reflected, and may be the upper limit value of the resin temperature, the time at which the resin temperature exceeds a predetermined temperature, or the upper limit value of an integral value obtained by integrating the resin temperature with the time when the resin temperature exceeds a predetermined temperature. These conditions may be determined experimentally or empirically in view of the properties of the internal component 52. If it is determined that the thermal condition is not satisfied, the composite molded component is determined as a defective composite molded component, and the processing proceeds to step S18. If it is determined that the thermal condition is satisfied, the composite molded component is determined as an accepted composite molded component, and the processing proceeds to step S17.

According to the present variation, it is possible to determine whether the thermal state of the internal component 52 is good or poor. Also, a composite molded component 50 that includes the overheated internal component 52 is processed as a defective composite molded component, and thus the occurrence of a defective composite molded component is suppressed.

The production method described above may further include the step of (k) determining, based on the output result of the pressure sensor 44, a feeding temperature at which the resin for forming the secondary molded portion 56 is fed into the mold 38.

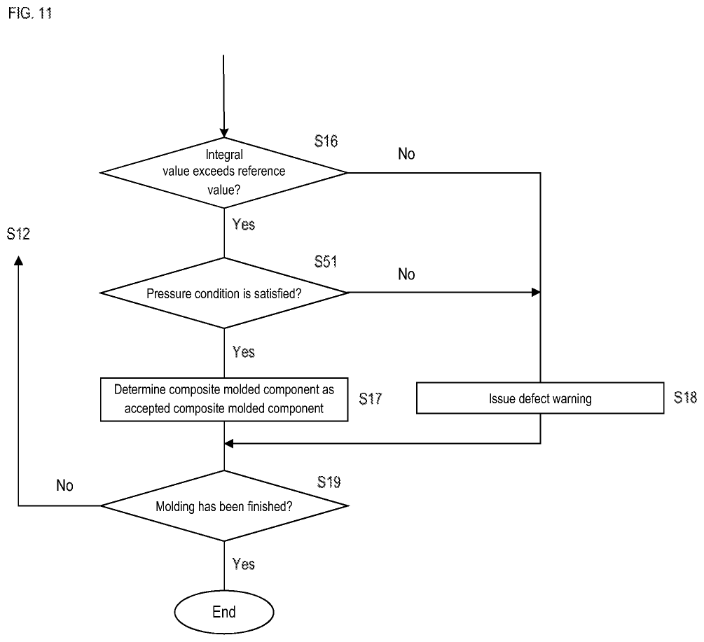

A flowchart according to the present variation is shown in FIG. 11. FIG. 11 is different from the flowchart shown in FIG. 6 in that step S51 has been added immediately after step S16. That is, if it is determined in step S16 that the integral value exceeds the reference value, the processing proceeds to step S51. In step S51, it is determined, based on the output result of the pressure sensor 44, whether or not a pressure condition is satisfied. The pressure condition is a pressure condition for the heat-molten resin to flow into the mold 38. The pressure condition is determined in advance based on the properties of the internal component 52. If the pressure is too low, the resin may not be fed sufficiently to the end portion that is distant from the injection inlet 31c. If the pressure is too high, an excessively large force may be applied to the primary molded portion 54 and the internal component 52. For this reason, as the pressure condition, appropriate upper and lower limit values are set. The upper and lower limit values may be experimentally or empirically set such that the resin is thoroughly fed into the mold, and an excessively large force is not applied to the primary molded portion 54 and the internal component 52. If it is determined that the pressure condition is not satisfied, the composite molded component is determined as a defective composite molded component, and the processing proceeds to step S18. If it is determined that the pressure condition is satisfied, the composite molded component is determined as an accepted composite molded component, and the processing proceeds to step S17.

According to the present variation, it is possible to determine whether the mold 38 is sufficiently filled with the resin for forming the secondary molded portion 56 while a large force is not applied to the internal component 52, the primary molded portion 54, and the like.

The structural elements described in the embodiment and the variations given above can be combined as appropriate unless they are technically contradictory to each other.

1. A method for producing a composite molded component that includes an internal component, a primary molded portion that covers the internal component, and a secondary molded portion that covers the primary molded portion, wherein a rib portion that protrudes toward the secondary molded portion is formed in the primary molded portion, the method comprising the steps of:
(a) placing an intermediate component that includes the internal component and the primary molded portion in a mold;
(b) pouring a resin for forming the secondary molded portion into the mold;
(c) detecting a resin temperature of the resin for forming the secondary molded portion in the mold;
(d) determining, based on the resin temperature, a melting time during which the resin for forming the secondary molded portion in the mold can be molten and fused to the rib portion of the primary molded portion;
(e) determining, based on the melting time, whether a molten state of the rib portion is good or poor; and
(f) releasing the composite molded component from the mold.

2. The method for producing a composite molded component according to claim 1, further comprising the step of:
(g) when it is determined in the step (f) that the molten state of the rib portion is poor, discarding the composite molded component that has been released from the mold.

3. The method for producing a composite molded component according to claim 1, further comprising the step of:
(h) when it is determined that the molten state of the rib portion is poor, changing a molding condition for next molding.

4. The method for producing a composite molded component according to claim 1, wherein, in the step (e), whether the molten state of the rib portion is good or poor is determined based on an integral value of the resin temperature during the melting time.

5. The method for producing a composite molded component according to claim 1, further comprising the step of:
(i) determining, based on a first temperature sensor and a second temperature sensor that are provided spaced apart from each other in the mold, a resin inflow rate of the resin for forming the secondary molded portion into the mold.

6. The method for producing a composite molded component according to claim 1, further comprising the step of:
(j), determining, based on the resin temperature of the resin for forming the secondary molded portion in the mold, whether or not the internal component satisfies a thermal condition.

7. The method for producing a composite molded component according to claim 1, wherein, in the step (c), the resin temperature of the resin for forming the secondary molded portion in the mold is a temperature of an extension of a surface of a portion of the resin for forming the secondary molded portion that covers the rib portion.

8. The method for producing a composite molded component according to claim 1, further comprising the step of:
(k) determining a feeding state of the resin for forming the secondary molded portion into the mold based on a pressure sensor that is provided in a mold surface of the mold at a position that is closer to an end of the mold and spaced apart from a resin injection inlet for injecting the resin for forming the secondary molded portion.

9. A composite molded component comprising:
an internal component;
a primary molded portion that covers the internal component; and
a secondary molded portion that covers the primary molded portion,
wherein a rib portion that protrudes toward the secondary molded portion is formed in the primary molded portion, and
a sensor mark is formed on a surface of the secondary molded portion.

10. The composite molded component according to claim 9,
wherein the sensor mark includes a first sensor mark and a second sensor mark that are formed at positions spaced apart from each other on the surface of the secondary molded portion.

11. The composite molded component according to claim 9, wherein a resin injection inlet mark is formed on the surface of the secondary molded portion, and
an end portion sensor mark is formed in the surface of the secondary molded portion at a position that is closer to an end of the secondary molded portion and spaced apart the resin injection inlet mark.
